(19) United States
(12) Patent Application Publication
(10) Pub. No.: US 2011/0168102 A1
(43) Pub. Date: Jul. 14, 2011

(54) Aqua-avian Exhibit

(76) Inventor: Patrick F. Kilroy, Lake Elsinore, CA (US)

(21) Appl. No.: 12/684,957

(22) Filed: Jan. 10, 2010

(51) Int. Cl. A01K 63/00

(52) U.S. Cl. 119/246

(57) ABSTRACT

An aquarium containing a completely submerged, substantially transparent, air chamber display case connected to the bottom floor of the aquarium. The aquarium contains an opening in the bottom floor to allow access to the air chamber display case from below. The aquarium is full of water and utilized to house aquatic animals. The air chamber display case is in fluid communication with the atmosphere and is utilized to display a bird. The aquarium is supported by an enclosed cabinet. A bird being temporarily displayed in the air chamber display case lives in a portable, self-contained, bird enclosure that is hidden from view beneath the aquarium and enclosed by the cabinet. An opening in the top of the bird enclosure is aligned with the access openings to the air chamber display case to allow the bird to travel from the bird enclosure to the air chamber display case.

### BACKGROUND OF THE INVENTION

This invention pertains to an article of manufacture in the field of animal husbandry (Class 119), more specifically to the subclasses aquarium combination and combined aquarium. The present invention relates to the integration of an aquarium combination combined with an enclosed cabinet that provides the illusion of viewing a pet bird living underwater with aquatic animals; however in reality, the bird is inside an air chamber display case at the bottom of the aquarium. Although the bird is temporarily displayed in the air chamber, the bird lives in a portable bird enclosure that is hidden from view beneath the aquarium combination and inside an enclosed cabinet that provides support for the aquarium. When exhibiting, the bird can freely travel from the bird enclosure to the air chamber display case.

The primary objective of the present invention is to provide the illusion of viewing a bird existing underwater with aquatic animals, while simultaneously providing for life support functions, ease of maintenance and ready access to the aquatic animals and bird being exhibited. The present invention provides an integrated aquarium and bird exhibit with advantageous features to enhance the illusionary objective and environment for the bird, as well as to simplify maintenance and access for the user.

Prior art attempts to achieve the illusionary objective were confounded by the need to provide an efficient method to facilitate life support functions and ready access to the aquatic animals and bird being displayed. For example, U.S. Pat. No. 296,853 granted to Ledig in 1884 reduced the illusionary objective by not completely submerging the air compartment occupied by the bird. Ledig's design provided an interior concealed air compartment to display a bird contained in the aquarium. This inner air compartment vertically traversed the entire aquarium, with openings to the atmosphere at the top and bottom. Access to the bird was provided by the removal of a cap on top of the aquarium, thus exposing the inner compartment. The need to access the bird from the top of the aquarium lessened the illusionary objective, wherein fish were unable to swim over the top of the bird. Furthermore, Ledig's design made maintenance cumbersome.

The design patents granted to Conrad (Pat. No. D251,206) in 1979 and Teats (Pat. No. D340,550) in 1993 for a “Combined Aquarium and Bird Cage” fail to preserve the illusionary objective. These designs fail to maintain the illusion of viewing the air breathing bird existing underwater in the aquarium by showing the viewer a logical access point to the bird and source of air from the atmosphere. In addition, Conrad's double walled annular aquarium design has inherent display and maintenance limitations. The formed double walled annular aquarium limits the aquatic animal display area for typical aquarium amenities, such as substrate (sand or gravel), plants and artificial décor. In addition, the double walled annular aquarium shape hinders applying standardized support systems for such things as filtration systems, light fixtures, hoods and heating elements.

Prior art for aquarium and terrarium combinations often attempted to provide a completely submerged terrarium providing all the life support functions for terrestrial animals within the terrarium itself, which is affixed to the inside the aquarium. For example, U.S. Pat. No. 4,958,593 to Hurlburt (1990) utilized such a design. The shortcoming of Hurlburt's design is inadequate access to the terrarium to provide life support functions, such as food, water, cleaning and care for a bird. Furthermore, Hurlburt's design diminishes the illusionary objective by clearly showing the method of access and source of air to the submerged terrarium from the space in between the vivarium and supporting legs.

Prior art's use of a fixed bird habitat often resulted in inadequate support for maintenance, lack of versatility and awkward access in providing life support functions. In addition, the fixed bird habitat did not provide for the proper well being of the bird.

Prior art lacks the utility to maintain the illusionary objective of viewing a bird existing underwater, while simultaneously providing for the ready access, ease of maintenance and proper well being of the aquatic animals and bird being displayed.

It is an object of the present invention to maintain the illusion of viewing a bird existing underwater in an aquarium by providing a completely submerged air chamber display case within the aquarium to allow aquatic animals to move around and over the top of the bird contained therein.

It is further object of the invention to foster the illusion of viewing a bird existing underwater in an aquarium by concealing the access opening to the air chamber display case and source of air for the bird from the intended viewer.

It is a further object of the invention to provide a separate, self-contained and portable bird enclosure that is accessible to the air chamber display case and is purposefully designed for housing a bird to facilitate care, access and well being of the animal; as well as to provide versatility to the pet owner.

It is a further object of the invention to provide a structural support system for the aquarium and bird enclosure that organizes the arrangement of the exhibit, enhances the visual effects and facilitates maintenance.

These and other objects of the present invention will become better understood from the detailed description which follows.

### BRIEF SUMMARY OF THE INVENTION

The present invention resolves the problems of prior art by utilizing key elements in a manner to foster the illusion of viewing a bird existing underwater in an aquarium, while simultaneously providing for life support functions, ease of maintenance and ready access to the aquatic animals and bird being exhibited. The invention comprises a substantially transparent aquarium full of water that is used to house aquatic animals. Contained inside the aquarium is a completely submerged, substantially transparent, air chamber display case connected to the bottom floor of the aquarium and is water tight. The aquarium contains an opening in the bottom floor to allow access to the air chamber display case from below. The air chamber display case is in fluid communication with the atmosphere and utilized to display a bird. The aquarium is supported by an enclosed cabinet, in which the bottom of the aquarium is in contact with the top of the enclosed cabinet. The submerged air chamber display case is accessible by the bird through an opening in both the floor of the aquarium and top of the enclosed cabinet.

A bird being temporarily displayed in the air chamber display case lives in a separate, self-contained and portable bird enclosure that is external to the aquarium and is hidden from view beneath the aquarium and enclosed by the cabinet. A door on the front of the enclosed cabinet provides ready access to the contents inside. The portable bird enclosure is self-contained to provide life support functions for the animal, including a location for food, water, waste and exercise. When exhibiting, an access opening in the top of the bird enclosure is aligned with the access opening to the air chamber display case above to allow the bird to travel from the bird enclosure to the air chamber display case.

### BRIEF DESCRIPTION OF THE SEVERAL VIEWS OF THE DRAWING

FIG. 1 is a perspective view of the subject invention;

FIG. 2 is a front view of FIG. 1;

FIG. 3 is a front view of FIG. 1 showing the enclosed cabinet door in the open position;

FIG. 4 is a side view of FIG. 1;

FIG. 5 is a perspective view of the enclosed cabinet;

FIG. 6 is a perspective view of the portable bird enclosure;

FIG. 7 is a perspective view of the portable bird enclosure showing the access opening with a hinged door on top; and

FIG. 8 is a perspective view of another preferred embodiment of the subject invention showing a bow front shaped aquarium and enclosed cabinet, with a rectangular shaped air chamber display case.

### DETAILED DESCRIPTION OF THE INVENTION

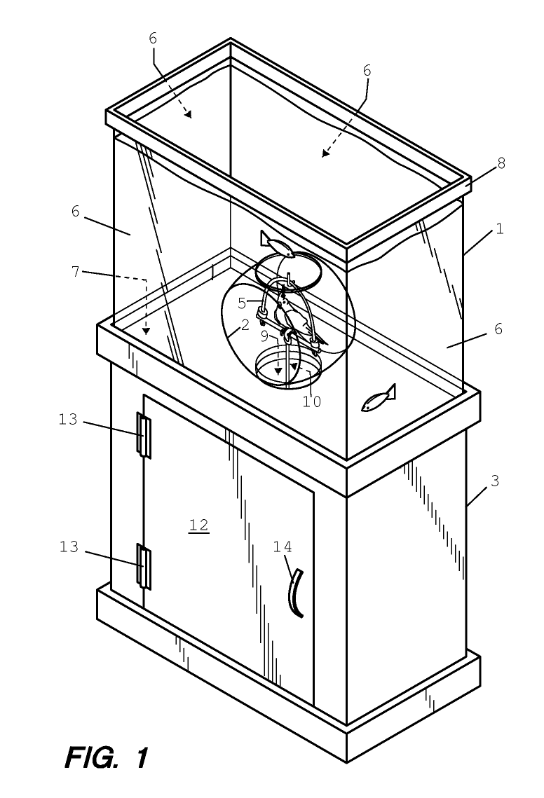

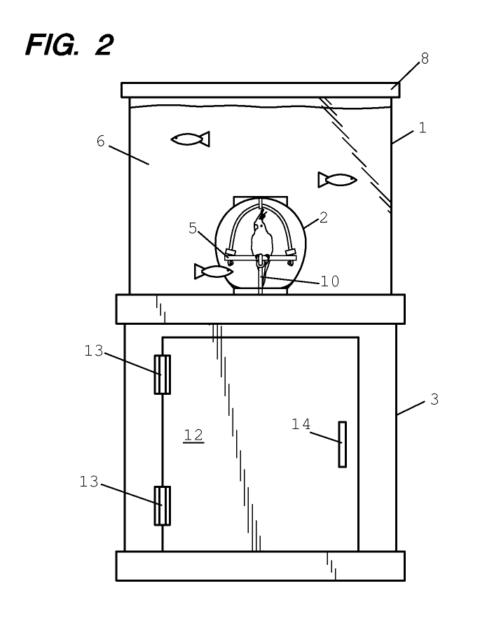

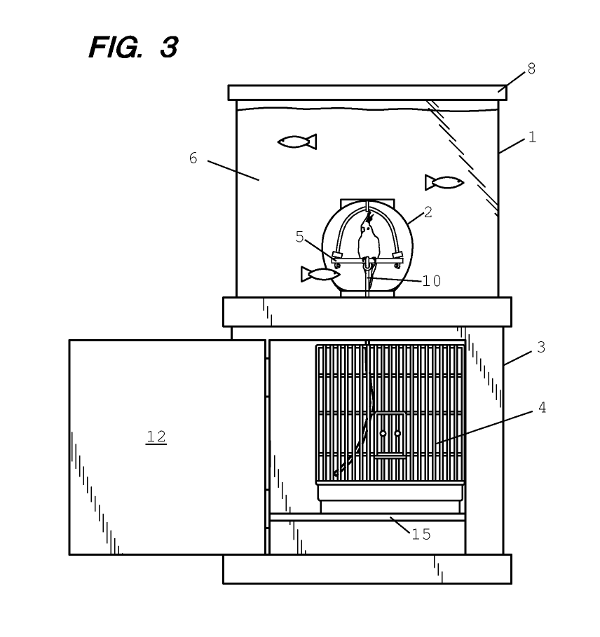

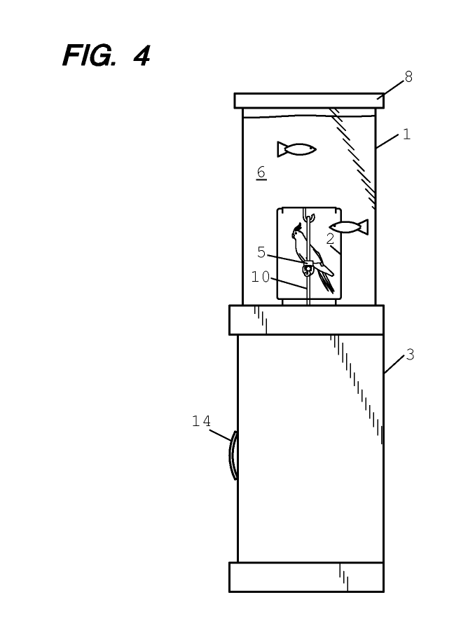

The preferred embodiment of the present invention of the Aqua-avian Exhibit comprises an aquarium containing a completely submerged air chamber display case mounted on top of an enclosed cabinet; inside the enclosed cabinet is a self-contained and portable bird enclosure. With reference to the drawings and particularly FIGS. 1, 2, 3 and 4, the aquarium 1 is made of substantially transparent plastic or glass material. Upright walls 6 and a bottom floor part 7 are joined by adhesive to form the aquarium 1. The top of the aquarium 1 is substantially open, as shown in FIG. 1; however, the upper and bottom edges of the walls may be additionally joined by a frame 8 to provide structural support. The frame can have an angle or channel to accept a cover or light fixture, as is well known in the aquarium art. The aquarium 1 is made to be completed filled with water and house aquatic animals. The aquarium 1 has an access opening 9 in the bottom floor part 7 that is large enough to accommodate the human hand.

Inside the aquarium 1 is an air chamber display case 2 made of substantially transparent plastic or glass material. Upright walls in cooperation with a top part and aquarium's bottom floor part 7 are joined to form the air chamber display case 2. The access opening 9 in the bottom floor part 7 of the aquarium 1 is contained within the bounds of the air chamber display case 2. The air chamber display case 2 is in fluid communication with the atmosphere and is water tight. The air chamber display case 2 is used to display a bird. The size of the access opening 9 is large enough to accommodate the human hand and may be co-extensive within the bounds of the air chamber display case 2. The access opening 9 provides continuous atmospheric air exchange to the air chamber display case 2, as well as access for the bird and pet owner.

A perch 5, made from rope and wood, is attached to the inside top of the air chamber display case 2. Attached to the perch 5 is a bird climbing device 10, such as a rope, as shown. Alternatively, the bird climbing device could be a ladder, chain or other climbing device as is commonly utilized in the bird industry.

The dimensions of the air chamber display case 2 are smaller than the aquarium 1, thereby creating a space for housing aquatic animals, such as fish, and for displaying artificial aquarium décor. The air chamber display case 2 is completely submerged underwater to allow aquatic animals to move over the top. A space is maintained between the air chamber display case 2 and interior walls of the aquarium 1, which allow aquatic animals room to move around all sides of the air chamber display case 2.

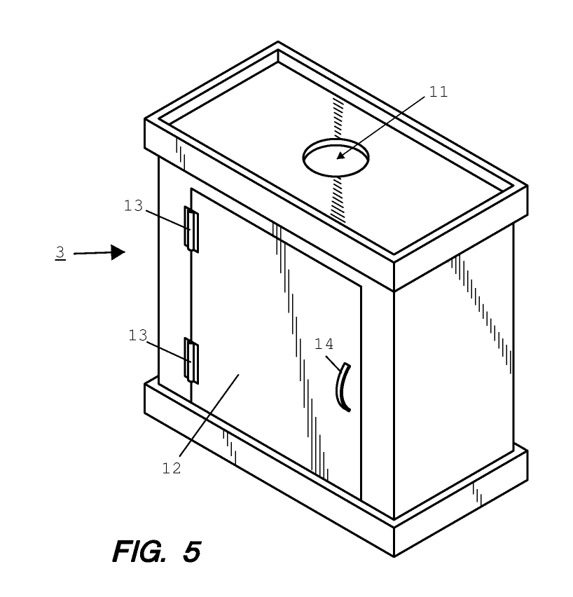

The combined aquarium 1 and air chamber display case 2 are supported by an enclosed cabinet 3. The top of the enclosed cabinet 3 has an opening 11, as shown in FIG. 5, which is equal or larger than the access opening 9 in the aquarium floor. The bottom of the aquarium 1 is in contact with the top of the enclosed cabinet 3, so that the aquarium 1 covers the opening 11 in the top of the enclosed cabinet 3. The access opening 9 in the bottom floor of the aquarium 1 is aligned with the opening 11 in the top of the enclosed cabinet 3 to permit access from underneath the enclosed cabinet 3 to the air chamber display case 2. The front of the enclosed cabinet 3 has an access door 12 to permit access to the contents inside. The access door 12 to the enclosed cabinet 3 has a handle 14 on the outside to facilitate opening. The enclosed cabinet 3 contains an adjustable shelf 15 inside for use as a platform to support a bird enclosure 4. The enclosed cabinet may also be used to house aquarium support systems, such as filters, air pumps and supplies.

Beneath the combined aquarium 1 and air chamber display case 2, and contained inside the enclosed cabinet 3 is a bird enclosure 4. The bird enclosure 4 is fully self-contained, portable and provides a living space for food, water, waste collection and exercise. The bird enclosure 4 is made of metal wire mesh mounted on a plastic tray, as shown, and is commonly used in the pet industry. Alternatively, the bird enclosure 4 could be made from substantially transparent plastic, glass or wire cage material or a combination of these materials. The bird enclosure 4 has a door 16 on the top. The door 16 may use a swinging motion to open, as shown, or alternatively, the door may use a horizontal sliding motion or be removable to open. The door is large enough to accommodate the human hand.

To exhibit the bird in the Aqua-avian Exhibit the adjustable shelf 15 is pre-positioned so the space between the top of the bird enclosure 4 and the inside bottom surface of the top of the enclosed cabinet 3 is small enough to prevent the escape of the bird. During the exhibit, the door 16 is placed in the open position and laid flat. In addition, the lower portion of the bird climbing device 10 is placed in the bird enclosure 4 to allow the bird to travel from the bird enclosure 4 to the perch 5 located inside the air chamber display case 2.

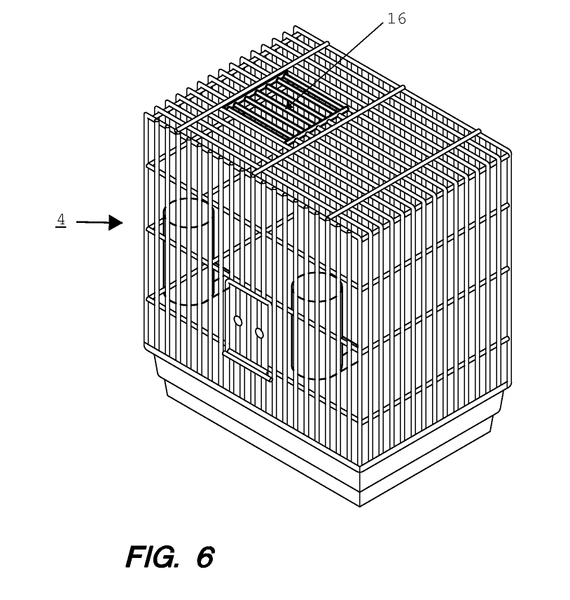

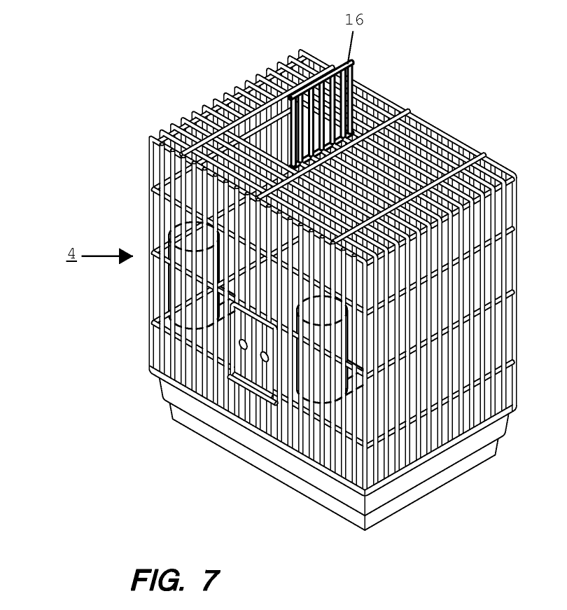

The bird enclosure 4 is portable, as shown in FIGS. 6 and 7, which facilitates maintenance and increases versatility for the pet owner. The bird enclosure 4 is self-contained, with areas for food, water, waste collection and exercise. When not exhibiting as part of the Aqua-avian Exhibit, the bird enclosure 4 can function as a portable pet carrier or the bird enclosure 4 can be temporarily placed at another location to increase the variety of surroundings for the well being of the bird.

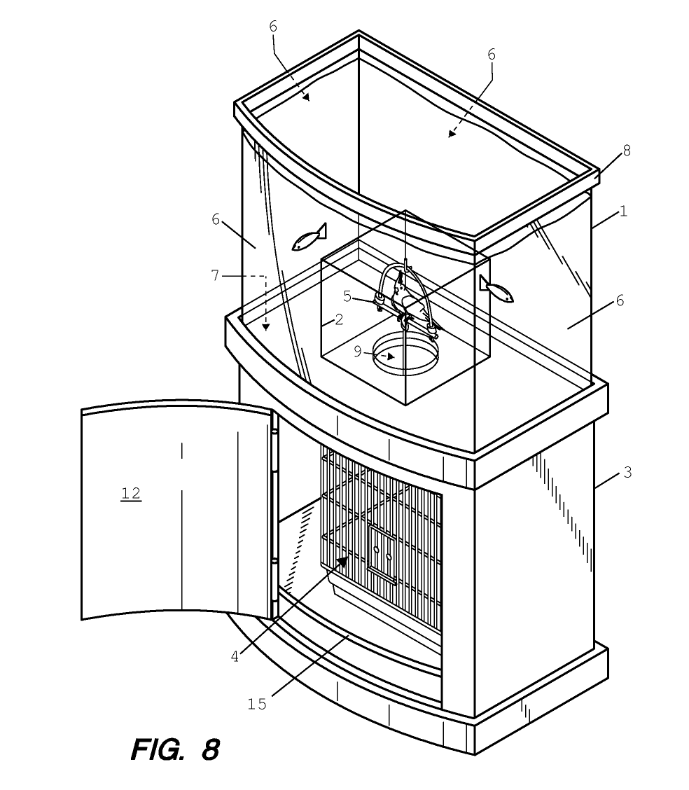

FIG. 8 shows another preferred embodiment of the subject invention. This embodiment comprises a bow front shaped aquarium 1 and enclosed cabinet 3, with a rectangular shaped air chamber display case 2.

One or more walls of the aquarium 1 may be straight, as shown in FIG. 1 or curved, as shown in FIG. 8. Similarly, one or more walls of the air chamber display case 2 may be curved, as shown in FIG. 1 or straight, as shown in FIG. 8. The walls of the aquarium 1 or air chamber display case 2 may be joined by adhesive to form a water tight seal or the walls may be molded and continuous around bends. Although the upper and bottom edges of the walls in FIGS. 1 and 8 are depicted with a frame 8, the frame is not always necessary, especially for rimless glass aquarium construction. Even though the walls of the aquarium 1 and air chamber display case 2 are upright, the walls need not be substantially vertical or planar. Therefore, the walls can have any shape or orientation, as is well known in the aquarium art.

The above presents a description of the best mode contemplated of carrying out the present invention, and of the manner and process of making and using it, in such full, clear, concise, and exact terms as to enable a person skilled in the art to which it pertains to make and use this invention. This invention is, however, susceptible to modifications and alternate construction from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention.

What I claim as my invention is:

1. An article of manufacture comprising:
a. a substantially transparent aquarium full of water that is used to house aquatic animals;
b. contained inside the aquarium is a completely submerged, substantially transparent air chamber display case used to display a bird;
c. an access opening in the shared bottom floor of the aquarium and air chamber display case is provided to access the air chamber display case from below, with the air chamber display case being in fluid communication with the atmosphere, the access opening is large enough to accommodate the human hand and may be co-extensive within the bounds of the air chamber display case;
d. the aquarium is supported on top of an enclosed cabinet, the top of the enclosed cabinet has an access opening that can be co-extensive within the bounds of the aquarium's bottom floor, the access opening in the enclosed cabinet is aligned with the access opening in the aquarium floor to permit access to the air chamber display case from inside the enclosed cabinet;
e. the submerged air chamber display case is accessible to a bird living in a separate, portable, bird enclosure that is concealed from view beneath the aquarium and enclosed by the cabinet, the bird enclosure is self-contained, with areas for food, water, waste collection and exercise;
f. the enclosed cabinet has a door on the front that permits ready access to the contents inside;
g. a perch is mounted inside the air chamber display case with a bird climbing device attached that extends downward into the bird enclosure; and
h. the bird enclosure has a door on top that is placed in the open position when displaying a bird, the bird can freely travel from the bird enclosure to the air chamber display case by flight or by utilizing the bird climbing device.

2. Said aquarium of claim 1 is made from substantially transparent plastic or glass material.

3. An article of manufacture comprising:
a. substantially transparent upright walls in cooperation with a bottom part form an aquarium, the aquarium is full of water and used to house aquatic animals;
b. substantially transparent upright walls in cooperation with a top part form a container that is joined to the bottom floor of the aquarium to form an air chamber display case;
c. an access opening in the shared bottom floor of the aquarium and air chamber display case is provided to access the air chamber display case from below, with the air chamber display case being in fluid communication with the atmosphere, where in the access opening is large enough to accommodate the human hand and may be co-extensive within the bounds of the air chamber display case, with the air chamber display case used to display a bird;
d. the air chamber display case is made to be completely submerged underwater within the aquarium;
e. the aquarium is supported on top of an enclosed cabinet, the top of the enclosed cabinet has an access opening that can be co-extensive within the bounds of the aquarium's bottom floor, the access opening in the enclosed cabinet is aligned with the access opening in the aquarium floor to permit access to the air chamber display case from inside the enclosed cabinet;
f. the submerged air chamber display case is accessible to a bird living in a separate, portable, bird enclosure that is concealed from view beneath the aquarium and enclosed by the cabinet, the bird enclosure is self-contained, with areas for food, water, waste collection and exercise;
g. the enclosed cabinet has a door on the front that permits ready access to the contents inside;
h. a perch is mounted inside the air chamber display case with a bird climbing device attached that extends downward into the bird enclosure; and
i. the bird enclosure has a door on top that is placed in the open position when displaying a bird, the bird can freely travel from the bird enclosure to the air chamber display case by flight or by utilizing the bird climbing device.

4. Said aquarium of claim 3 is made from substantially transparent plastic or glass material.
